(19) United States
(12) Patent Application Publication
(10) Pub. No.: US 2020/0140077 A1
(43) Pub. Date: May 7, 2020

(54) BIDIRECTIONAL AIRCRAFT ROTOR

(71) Applicant: Bell Helicopter Textron Inc., Fort Worth, TX (US)

(72) Inventors: Aaron Alexander Acee, Flower Mound, TX (US); Andrew Paul Haldeman, Fort Worth, TX (US)

(73) Assignee: Bell Helicopter Textron Inc., Fort Worth, TX (US)

(21) Appl. No.: 16/178,349

(22) Filed: Nov. 1, 2018

(51) Int. Cl. B64C 27/82; G05D 1/08

(52) U.S. Cl. CPC B64C 27/82; B64C 2027/8254; B64C 2027/8227; G05D 1/0808

(57) ABSTRACT

A bidirectional aircraft rotor for a rotorcraft tail rotor. The rotorcraft tail rotor uses a hub and a first tail rotor blade affixed to the hub. A pitch of the first tail rotor blade is fixed, and a profile of a leading edge of the first tail rotor blade is identical to a profile of a trailing edge of the first tail rotor blade. The tail rotor is driven by a torque source, such as an electric motor or an engine. The tail rotor uses variable RPM and reversible rotational direction to provide rotorcraft with yaw control.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Conventional rotorcraft feature rotor systems that spin in a single direction. Rotor systems that rotate a single direction utilize rotor blades, or airfoils, specifically configured for a chordwise airstream passing over the rotor blades in a single direction. Conventional rotor blades typically feature a maximum thickness offset closer to a leading edge than the trailing edge, such as between a leading edge of the blade and about one-third of a chord length of the blade nearest the leading edge. The offset maximum thickness and/or camber of conventional airfoils is optimized to generate lift as the airfoil is rotated in a single “normal” direction. Conventional rotors typically operate at a relatively constant RPM and are pitch controlled, wherein their blades are rotated about a spanwise pitch axis to vary the amount of lift generated by the blades.

### BRIEF DESCRIPTION OF THE DRAWINGS

FIG. 1 is a side view of a rotorcraft according to this disclosure.

FIG. 2 is an end view of a bidirectional rotor blade according to this disclosure.

FIG. 3 is an end view of another bidirectional rotor blade according to this disclosure.

FIG. 4 is a side view of another rotorcraft according to this disclosure.

FIG. 5 is a partial side view of a tail boom comprising rotors according to this disclosure.

FIG. 6 is a partial side view of another tail boom comprising rotors according to this disclosure.

FIG. 7 is a partial side view of another tail boom comprising rotors according to this disclosure.

### DETAILED DESCRIPTION

In this disclosure, reference may be made to the spatial relationships between various components and to the spatial orientation of various aspects of components as the devices are depicted in the attached drawings. However, as will be recognized by those skilled in the art after a complete reading of this disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

This disclosure describes a rotorcraft having rotors that can change a direction of their rotation and are utilized on rotor systems that vary RPM of the rotor. Changing the direction of a rotor's rotation requires rotor blades that are configured for relatively efficient operation in both directions. The bidirectional rotor blades feature a leading edge along with a trailing edge that are mirrors of each other along a median of the rotor blade. A profile of the leading edge of the rotor blade is identical to a profile of the trailing edge of the rotor blade.

A bidirectional rotor system will have to provide thrust when operated in both the forward direction, with a leading edge leading, and the negative direction, with the trailing edge leading, and an airfoil with a relatively sharp leading edge and a rounded trailing edge will provide lesser flow separation in both rotational directions. Bidirectional rotor systems also present a challenge in requiring the rotor to stop and change directions, but RPM-controlled rotors are typically designed to have reduced chord length and inertia.

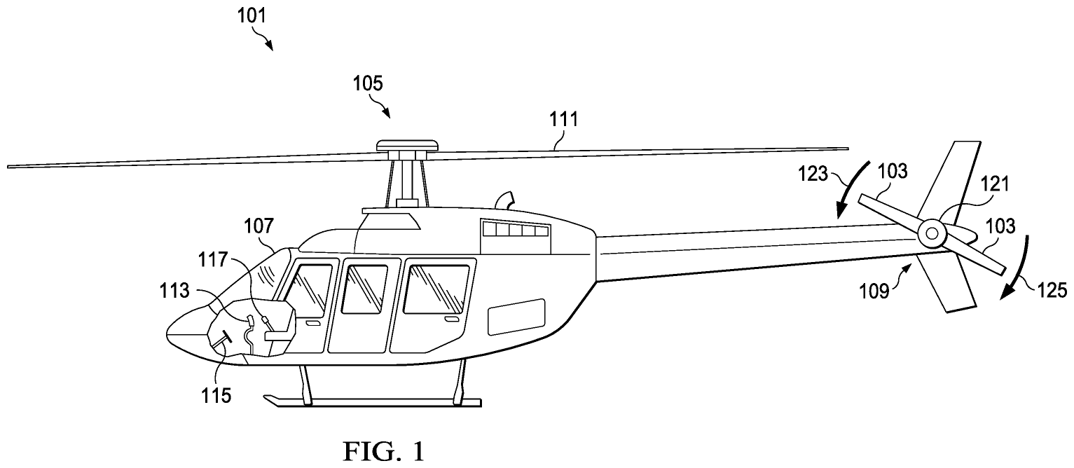

FIG. 1 illustrates a rotorcraft 101 equipped with a bidirectional rotor blade 103 according to this disclosure. Rotorcraft 101 comprises a main rotor system 105 carried by a fuselage 107 and a tail rotor system 109 carried by the fuselage 107. One or more main-rotor blades 111 operably associated with main rotor system 105 provide lift for rotorcraft 101 and are controlled with a plurality of control sticks within the fuselage 107. For example, during flight a pilot can manipulate cyclic stick 113 to cyclically change the pitch angle of main rotor blades 111, thus providing lateral and longitudinal flight direction, and/or manipulate pedals 115 for controlling yaw direction with varied RPM and rotational direction of the tail rotor system. Furthermore, the pilot can adjust the collective stick 117 to collectively change the pitch angles of all the main-rotor blades 111.

Tail rotor system 109 utilizes a bidirectional aircraft rotor blade 103 having a fixed pitch and configured for producing a yaw moment of a selected magnitude and a selective direction. Because the bidirectional aircraft rotor blade 103 is fixed in pitch, the RPM and the direction of rotation are varied by manipulation of the pedals 115 to vary the magnitude and direction of the yaw moment. Rotorcraft 101 features a torque source, such as an engine or electric motor, driving the main rotor system 105 along with the tail rotor system 109. Tail rotor system 109 can be rotationally coupled to a transmission comprising a clutch that enables the tail rotor system 109 to both vary the RPM and the rotational direction of the tail rotor system 109. Alternatively, the tail rotor system 109 is driven by a dedicated bidirectional electric motor. In either case, the bidirectional aircraft rotor blade 103 is affixed to a hub 121.

The bidirectional aircraft rotor blade 103 is comprised of a leading edge that is identical to a trailing edge, both having identical rounded edge profiles. Furthermore, the bidirectional aircraft rotor blade 103 is comprised of an upper surface having a greater upper camber as compared to a lower camber of the lower surface. The combination of the camber and fixed pitch make the bidirectional rotor blade 103 efficient in a forward direction 123, but results in the bidirectional aircraft rotor blade 103 being less efficient in a reverse direction 125.

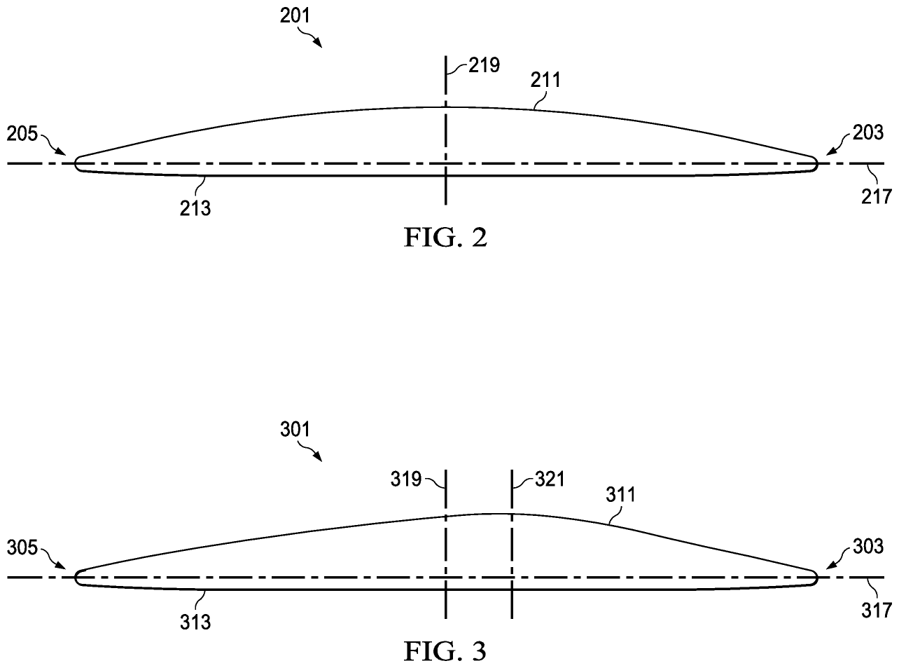

FIG. 2 illustrates a bidirectional aircraft rotor blade 201 for a rotorcraft. Rotor blade 201 is comprised of a leading edge 203, a trailing edge 205, an upper surface 211, and a lower surface 213. Chord axis 217 connects the leading edge 203 and the trailing edge 205. The median axis 219 is located midway along the chord axis between the leading edge 203 and the trailing edge 205. The upper surface 211 connects the leading edge 203 to the trailing edge 205, and the lower surface 213 connects the leading edge 203 to the trailing edge 205.

A thickness of the rotor blade 201 is at its maximum at the median axis 219. Furthermore, the leading edge 203 and the trailing edge 205 are identical in profile shape, and the rotor blade 201 is mirrored about the median axis. Placing the maximum thickness position at 50% of the chord length makes the rotor blade symmetric about the median axis 219, which provides reverse direction performance. In a preferred embodiment, the lower camber is at or below 2% to help reverse direction performance.

FIG. 3 illustrates a bidirectional aircraft rotor blade 301 for a rotorcraft. Rotor blade 301 is comprised of a leading edge 303, a trailing edge 305, an upper surface 311, and a lower surface 313. Chord axis 317 connects the leading edge 303 and the trailing edge 305. A median axis 319 is located midway between the leading edge 303 and the trailing edge 305. The upper surface 311 connects the leading edge 303 to the trailing edge 305, and the lower surface 313 connects the leading edge 303 to the trailing edge 305.

A maximum thickness axis 321 is located where a thickness of the rotor blade 301 is at a maximum, and the axis 321 is located a distance away from the median axis 319, resulting in the rotor blade 301 being non-symmetric about the median axis 319. The leading edge 303 and the trailing edge 305 are identical in profile shape.

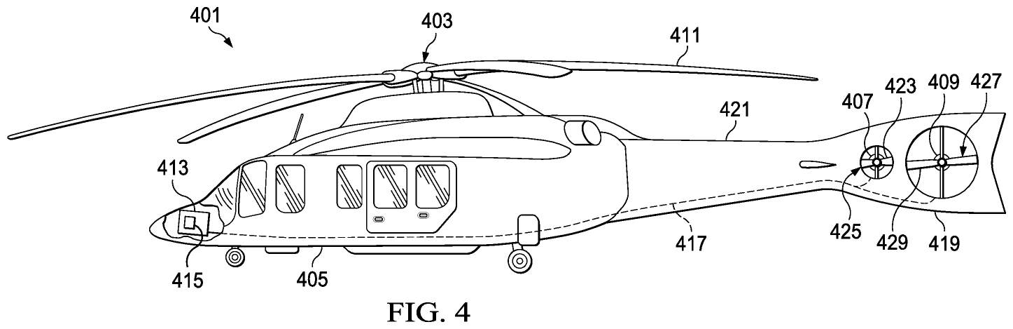

FIG. 4 illustrates a rotorcraft 401 equipped with two bidirectional rotor systems according to this disclosure. Rotorcraft 401 comprises a main rotor system 403 carried by a fuselage 405, a first tail rotor system 407, and a second tail rotor system 409. One or more main-rotor blades 411 operably associated with main rotor system 403 provide lift for rotorcraft 401 and are controlled with a flight control computer 413 having a tail rotor controller 415. For example, during flight a pilot can manipulate a cyclic stick to cyclically change the pitch angle of main rotor blades 411, thus providing lateral and longitudinal flight direction, and/or manipulate pedals for controlling yaw direction by varying the RPM and reversing the direction of the first and second tail rotor systems 407, 409. The pilot can adjust a collective stick to collectively change the pitch angles of all of the main rotor blades 411.

The flight control computer 413 and the tail rotor controller 415 are wired 417 to the first tail rotor system 407 and wired to the second tail rotor system 409. Both the first tail rotor system 407 the second tail rotor system 409 are in the tail rotor assembly 419. The tail rotor assembly 419 of rotorcraft 401 is attached to the fuselage 405 of the rotorcraft 401 by tail boom 421. The first tail rotor system 407 is comprised of a first tail rotor blade 423 and a second tail rotor blade 425. The second tail rotor system 409 is comprised of a third tail rotor blade 427 and a fourth tail rotor blade 429. The flight control computer 413 can selectively adjust the RPM of each tail rotor system and the direction of rotation of each tail rotor system to produce a yaw moment of a selected magnitude and direction for varying the yaw attitude of the rotorcraft 401.

The first tail rotor system 407 is driven by a first electric motor. A pitch of the first tail rotor blade 423 and the second tail rotor blade 425 is fixed. The RPM and/or a direction of rotation of the first electric motor is varied to vary a yaw moment of the first tail rotor system 407.

The second tail rotor system 409 is driven by a second electric motor. A pitch of the third tail rotor blade 427 and the fourth tail rotor blade 429 is fixed. The RPM and/or a direction of rotation of the first electric motor is varied to vary a yaw moment of the first tail rotor system 409.

Combining the yaw moment of the first tail rotor system 407 with the yaw moment of the second tail rotor system 409 allows the pilot to quickly and efficiently yaw the aircraft. In the preferred embodiment the first tail rotor system 407 has a smaller diameter than the second tail rotor system 409. In alternative embodiments, each tail rotor system is equal in diameter or first tail rotor system 407 has a larger diameter than the second tail rotor system 409.

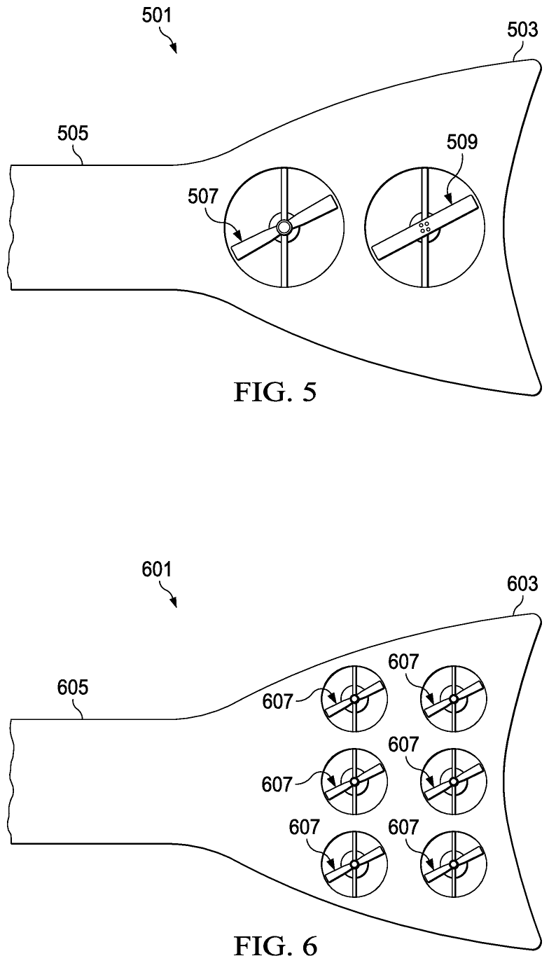

FIG. 5 illustrates a rotorcraft's tail boom equipped with two tail rotors having bidirectional aircraft rotor blades according to this disclosure. Combined tail rotor system 501 is in a vertical stabilizer 503 attached to tail boom 505. Combined tail rotor system 501 is comprised of a first tail rotor system 507 and second tail rotor system 509 of equal diameter. Each tail rotor system in the combined tail rotor system 501 is fixed in pitch and features bidirectional aircraft rotor blades like those of the bidirectional aircraft rotor 301. Second tail rotor system 509 is comprised of a single blade that spans an entire length of the tail rotor system. In the preferred embodiment, the first tail rotor system 507 is controlled concurrently with the second tail rotor system 509. Alternatively, the first tail rotor system 507 is controlled independently of the second tail rotor system 509.

FIG. 6 illustrates a rotorcraft's tail boom equipped with an array of tail rotors having bidirectional aircraft rotor blades according to this disclosure. Combined tail rotor system 601 is in a vertical stabilizer 603 attached to tail boom 605. Combined tail rotor system 601 is comprised of a plurality of tail rotor systems 607 having equal diameters. Each tail rotor system in the combined tail rotor system 601 is fixed in pitch and features bidirectional aircraft rotor blades like those of the bidirectional aircraft rotor 301.

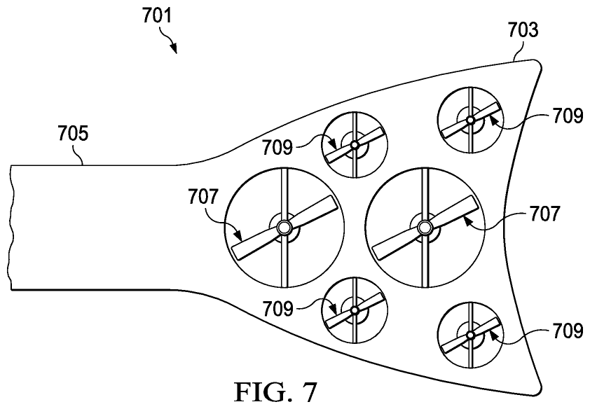

FIG. 7 illustrates a rotorcraft's tail boom equipped with several tail rotors having bidirectional aircraft rotor blades according to this disclosure. Combined tail rotor system 701 is in a vertical stabilizer 703 attached to tail boom 705. Combined tail rotor system 701 is comprised of a plurality of larger tail rotor systems 707 and smaller tail rotor systems 709. Each tail rotor system 707, 709 in the combined tail rotor system 701 is fixed in pitch and features bidirectional aircraft rotor blades such as the bidirectional aircraft rotor 301. It should be apparent that tail rotor systems 707, 709 while shown as providing yaw control could be mounted horizontally to provide lift to rotorcraft.

It should be noted that the bidirectional aircraft rotor provides thrust while moving in both forward and reverse directions. The bidirectional aircraft rotor provides rotorcraft with quicker and more efficient control of yaw during flight, thereby enabling the rotorcraft to be more responsive to the pilot and the flight control system.

At least one embodiment is disclosed, and variations, combinations, and/or modifications of the embodiment(s) and/or features of the embodiment(s) made by a person having ordinary skill in the art are within the scope of this disclosure. Alternative embodiments that result from combining, integrating, and/or omitting features of the embodiment(s) are also within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

What is claimed is:

1. A tail rotor for a rotorcraft, comprising:
a hub driven by a torque source; and
a first tail rotor blade affixed to the hub;
wherein a pitch of the first tail rotor blade is fixed; and
wherein a profile of a leading edge of the first tail rotor blade is identical to a profile of a trailing edge of the first tail rotor blade.

2. The tail rotor of claim 1, further comprising:
a second tail rotor blade affixed to the hub.

3. The tail rotor of claim 1, wherein a maximum thickness of the first tail rotor blade is midway between the leading edge and the trailing edge.

4. The tail rotor of claim 3, wherein an upper camber is greater than a lower camber.

5. The tail rotor of claim 4, wherein the lower camber is less than or equal to 2 percent.

6. The tail rotor of claim 4, wherein a maximum of the upper camber is located where the maximum thickness is located.

7. The tail rotor of claim 1, wherein the torque source is an electric motor.

8. The tail rotor of claim 1, wherein the torque source is an engine.

9. A rotorcraft having a main rotor system, comprising:
a first tail rotor system having;
bidirectional rotor blades with a fixed pitch; and
a first torque source configured to rotate the first tail rotor system;
wherein an RPM of the first torque source is variable; and
wherein a direction of rotation of the first tail rotor system is reversible in flight.

10. The rotorcraft of claim 9, wherein the torque source is an electric motor.

11. The rotorcraft of claim 9, further comprising:
a second tail rotor system having;
bidirectional rotor blades with a fixed pitch; and
a second torque source configured to rotate the second tail rotor system;
wherein an RPM of the second torque source is variable; and
wherein a direction of rotation of the second tail rotor system is reversible in flight.

12. The rotorcraft of claim 11, wherein a diameter of the first tail rotor system is unequal to a diameter of the second tail rotor system.

13. The rotorcraft of claim 11, wherein a diameter of the first tail rotor system is equal to a diameter of the second tail rotor system.

14. The rotorcraft of claim 9, further comprising:
a third tail rotor system having;
bidirectional rotor blades with a fixed pitch; and
a third torque source configured to rotate the third tail rotor system;
wherein the third tail rotor system is fixed in pitch;
wherein an RPM of the third tail rotor system is variable; and
wherein a direction of rotation of the third tail rotor system is reversible in flight.

15. A method of controlling a yaw moment of a tail rotor system of a rotorcraft, comprising:
providing a first tail rotor system having;
a first hub; and
a first tail rotor blade affixed to the first hub with a fixed pitch;
wherein a profile of a leading edge of the first tail rotor blade is identical to a profile of a trailing edge of the first tail rotor blade; and
varying an RPM of the first tail rotor system.

16. The method of claim 15, further comprising:
reversing a direction of rotation of the first tail rotor system.

17. The method of claim 15, further comprising:
providing a second tail rotor system having;
a second hub; and
a second tail rotor blade affixed to the second hub with a fixed pitch;
wherein a profile of a leading edge of the second tail rotor blade is identical to a profile of a trailing edge of the second tail rotor blade; and
varying an RPM of the second tail rotor system.

18. The method of claim 17, further comprising:
reversing a direction of rotation of the second tail rotor system.

19. The method of claim 17, wherein the first tail rotor system is controlled concurrently with the second tail rotor system.

20. The method of claim 17, wherein the first tail rotor system is controlled independently of the second tail rotor system.
